(19) United States
(12) Patent Application Publication
(10) Pub. No.: US 2014/0299806 A1
(43) Pub. Date: Oct. 9, 2014

(54) SHUT-OFF VALVE

(71) Applicant: Airbus Operations GmbH, Hamburg (DE)

(72) Inventor: Lars Hoffmann, Stuhr (DE)

(21) Appl. No.: 14/244,928

(22) Filed: Apr. 4, 2014

(30) Foreign Application Priority Data
Apr. 5, 2013 (DE) 10 2013 206 097.1

(51) Int. Cl. F16K 39/06

(52) U.S. Cl. CPC F16K 39/06
USPC 251/283

(57) ABSTRACT

A shut-off valve is provided. The shut-off valve includes a valve body having an inlet and an outlet, and a shut-off element, which is arranged in the valve body and through which a shut-off element through-channel is formed, which ends at its two ends in two mutually spaced first openings in an outer surface of the shut-off element. The shut-off element is movable between a shut-off position, in which the shut-off element blocks a fluid flow, and a flow position, in which the shut-off element allows a fluid flow between the inlet and the outlet of the valve body through the shut-off element through-channel. The shut-off element includes a first pressure-compensation channel opening with an inner end into the shut-off element through-channel, and the valve body includes a second pressure-compensation channel.

### CROSS-REFERENCE TO RELATED APPLICATION

This application claims priority to German Patent Application No. 10 2013 206 097.1, filed Apr. 5, 2013, which is incorporated herein by reference in its entirety.

### TECHNICAL FIELD

The technical field relates to a shut-off valve, such as a ball-type shut-off valve, and in particular to a shut-off valve for shutting off the feed of a compressed or pressurized gas from a compressed or pressurized gas source, for example in a hydraulic system. The technical field also relates to a compressed gas system, to a hydraulic system and to a vehicle or aircraft having a shut-off valve of this type.

### BACKGROUND

It is necessary in many fields of technology to be able to selectively shut off the flow of a gaseous or liquid fluid. Shut-off valves or gates are used for this purpose. Ball-type shut-off valves constitute a frequently used type of such shut-off valves and are also referred to as ball or spherical cocks or ball or spherical valves. As a shut-off element or closure element, they have a ball or spherical disk which is provided with a through-channel or a through-bore, is mounted rotatably in a hollow space of a valve body or valve casing, and, by suitable rotation, can selectively allow or block a fluid flow through the valve casing between an inlet channel and an outlet channel of the valve casing. To this end, the hollow space and the shut-off element are arranged between the inlet channel and the outlet channel in the fluid flow direction, and the shut-off element can be rotated into a first position, in which the through-channel thereof is aligned with the inlet channel and the outlet channel such that fluid can flow from the inlet channel through the through-channel to the outlet channel, and can be rotated, usually with a rotation through 90°, into a second position, in which the through-channel is not aligned with the inlet channel and the outlet channel and a fluid flow between the inlet channel and the outlet channel is prevented.

When using shut-off valves in fluid systems, such as pneumatic or hydraulic systems, it is often desirable or necessary, once a shut-off valve has closed, to be able to effect a pressure compensation quickly and in a controlled manner in the region of the fluid system pressurized by the previous fluid feed or supply and shut off by the closure of the shut-off valve, for example in order to carry out maintenance works at the shut-off region.

An example of this can be found in hydraulic systems of vehicles and in particular of aircraft. The hydraulic fluid is stored in a hydraulic fluid reservoir, from which, using pumps, it is drawn, compressed, and fed at high pressure into the consumer circuit. Once the work has been completed, the pressure-relieved hydraulic fluid is fed again to the hydraulic fluid reservoir. The hydraulic fluid is therefore guided in a closed circuit.

In order to ensure efficient drawing of the hydraulic fluid from the hydraulic fluid reservoir by means of the pumps, the hydraulic fluid reservoir may be pressurized or acted on by compressed air. For this purpose, compressed air is removed from a compressed air source, such as the compressed air system of an aircraft, is conditioned in a compressed air system and is then fed to the hydraulic fluid reservoir. The conditioning typically comprises the cooling, dewatering and reduction of the compressed air to a required pressure level. To maintain the function of such a compressed air system, said system must be regularly dewatered, that is to say the water separated from the compressed air must be drained. To this end, the compressed air system must typically be switched to a pressure-free state by stopping the compressed air feed or supply on the one hand and by effecting a pressure compensation or equalization on the other hand in order to bring the compressed air system to the surrounding atmospheric pressure. A ball-type shut-off valve may be provided for stopping the compressed air feed. Since the compressed air system, once shut off has been effected, is still pressurized with a residual pressure due to low internal leakage rates and the absence of compressed air removal, said residual pressure possibly impairing or even preventing the function of a drain valve for dewatering the compressed air system, it may be necessary to provide a separate pressure-compensation valve.

The use of a shut-off valve and in particular of a ball-type shut-off valve in such an arrangement and generally in an arrangement in which a pressure compensation is to be effected in a region of a fluid system shut off by means of a shut-off valve is therefore laborious and relatively complicated.

In addition, other objects, desirable features and characteristics will become apparent from the subsequent summary and detailed description, and the appended claims, taken in conjunction with the accompanying drawings and this background.

### SUMMARY

Accordingly, the various teachings of the present disclosure provides a device that is of simpler construction and is easier to operate, with which a fluid flow in a fluid system can be shut off and a pressure compensation can be effected in a shut-off region of the fluid system.

In accordance with the present disclosure a shut-off valve, such as a ball-type shut-off valve (or ball or spherical cock or ball or spherical valve), comprises a valve body with an inlet and an outlet, for example, in the form of an inlet channel and an outlet channel, respectively. The shut-off valve further comprises a shut-off element or shut-off body arranged in the valve body, through which a through-channel or a through-bore is formed. The through-channel terminates or ends at its two ends (as viewed in the direction of extension through the shut-off element) in two mutually spaced first openings in an outer surface of the shut-off element.

The shut-off element is mounted or supported in the valve body in such a way that it can be moved, for example rotated, between a shut-off position, in which the shut-off element blocks a fluid flow between the inlet and the outlet of the valve body, and a flow position of the shut-off element, in which the shut-off element allows a fluid flow between the inlet and the outlet of the valve body through the shut-off element through-channel.

In addition to the through-channel, the shut-off element comprises a first pressure-compensation or pressure-equalization channel opening with a first or inner end into the shut-off element through-channel, and the valve body comprises a second pressure-compensation or pressure-equalization channel. The first and the second pressure-compensation channel and the shut-off element through-channel are arranged and designed such that on the one hand, in the shut-off position of the shut-off element, the shut-off element allows a fluid flow or pressure compensation from the outlet into a second or outer end of the first pressure-compensation channel, from the first pressure-compensation channel into the shut-off element through-channel, and from or out of the shut-off element through-channel through one of the first openings thereof, generally directly, into the second pressure-compensation channel. In other words, at least part of the shut-off element through-channel and one of the first openings thereof form part of a fluid flow path via which fluid, for pressure compensation or equalization, can flow from the outlet into and through the second pressure-compensation channel. On the other hand, the shut-off element, in the release position of the shut-off element, blocks a fluid flow or pressure compensation between the outlet and the second pressure-compensation channel. The inner end and the outer end of the first pressure-compensation channel are the ends of the first pressure-compensation channel in the direction of extension thereof through the shut-off element. The second pressure-compensation channel is generally connected to the outside of the valve body or generally opens to the outer surface of the valve body, such that the pressure compensation can take place with the surroundings or exterior of the shut-off valve.

This configuration and construction has the advantage that, besides the shut-off valve, there is no need to provide a separate valve for pressure compensation of a shut-off region of a fluid system in which the shut-off valve is arranged. This leads to a reduction of the complexity of the fluid system and to a weight saving, which is of significance in particular in aircraft, for example. In addition, the pressure compensation may advantageously be effected easily simultaneously with the closing of the shut-off valve without an additional process or operating step. At the same time, the shut-off valve is of simple structure and the complexity compared with a conventional shut-off valve is only increased insignificantly.

In one embodiment the second pressure-compensation channel and the shut-off element through-channel are further arranged and designed such that, in the shut-off position of the shut-off element, an end of the second pressure-compensation channel lies or is located directly at one of the first openings of the shut-off element through-channel, and, in the flow position of the shut-off element, this end of the second pressure-compensation channel is closed directly by the valve body, that is to say a fluid flow into the second pressure-compensation channel through this end is blocked by the valve body.

It may be preferable if the inlet, the outlet, the shut-off element through-bore and the first and the second pressure-compensation channel are arranged such that, as the shut-off element moves from the flow position into the shut-off position, a fluid stream or a fluid flow between the inlet and the outlet is at first blocked before the pressure compensation or fluid flow between the outlet and the second pressure-compensation channel is enabled.

In one embodiment the shut-off element through-channel and the first pressure-compensation channel are substantially straight, and the first pressure-compensation channel extends substantially perpendicularly to the shut-off element through-channel. This embodiment can be realized particularly easily. In this embodiment and also independently thereof, it may also be preferable if the second pressure-compensation channel is substantially straight.

In one embodiment the first pressure-compensation channel opens into the shut-off element through-channel in the middle between the two ends of the shut-off element through-channel in the direction of extension through the shut-off element or in the middle between the two first openings of the shut-off element through-channel.

In accordance with one embodiment the shut-off element is rotated through about 90° as it moves between the flow position and the shut-off position, that is to say the flow position and the shut-off position are separated from one another by about 90° in the direction of rotation.

In one embodiment the diameter of the first pressure-compensation channel and/or of the second pressure-compensation channel is smaller than the diameter of the shut-off element though-channel, of the inlet and of the outlet, and/or the diameter of the first pressure-compensation channel is smaller than the diameter of the second pressure-compensation channel. This embodiment takes into consideration the fact that smaller line cross sections are desirable for the pressure compensation than for the “regular” fluid flow.

In one embodiment of the shut-off valve, in which said valve is for example, a ball-type shut-off valve (or ball or spherical cock or ball or spherical valve), the valve body, which in one example can be formed as a casing, has a cavity or hollow space which is delimited by an inner surface of the valve body. The inlet is formed by an inlet channel, provided in the valve body, for allowing fluid to enter the valve body, and the outlet is formed by an outlet channel, provided in the valve body, for allowing fluid to exit from the valve body. The inlet channel and the outlet channel, which are substantially straight and for example may have a circular or other cross-sectional shape, open into the cavity at mutually spaced mouths. The mouths are formed by corresponding mouth openings, of which the shapes correspond generally to the shape of the inlet channel and outlet channel respectively. The inlet channel, the outlet channel and the cavity form a passage or at least part of a passage through the valve body, wherein fluid, which enters the valve body through the inlet channel, can flow through the valve body through the passage and can exit from the valve body through the outlet channel. The cavity is arranged along the passage between the inlet channel and the outlet channel.

In this embodiment, but also in other embodiments, the shut-off element or closure element, if the shut-off valve is embodied as a ball-type shut-off valve, may for example be provided in the form of a ball or a spherical disk or a ball ring, and/or the outer surface thereof can be curved spherically for example or may have at least one spherically curved and annularly closed portion. The two first openings are formed here generally in a spherically curved portion of the outer surface. If the shut-off element is provided in the form of a ball or a spherical disk, the shut-off element through-channel generally extends through the center of the ball or of the full sphere corresponding to the spherical disk and is further arranged generally symmetrically with respect to the ball or spherical disk. It is noted in this connection that, if the shut-off valve is embodied as a ball-type shut-off valve, certain deviations from the ball shape and from a spherical curvature of the outer surface or at least a portion of the outer surface are possible and, depending on the intended application, desirable, for example in order to improve a seal between the shut-off element and the valve body. If the shut-off element is configured in the manner of a spherical disk, it may be preferable if the spherical disk corresponds to a disk cut out symmetrically from a full sphere, that is to say if the two parallel cut faces are spaced on both sides equally from a plane running through the center of the full sphere. In the case of a spherical disk, the outer surface is annular and is formed by the part of the outer surface of the spherical disk corresponding to the full sphere.

Further, the shut-off element is in this embodiment arranged in the cavity, irrespective of whether or not the shut-off valve is formed as a ball-type shut-off valve or the shut-off element is formed in the manner of a ball or spherical disk, and is supported rotatably about at least one axis, which can be implemented either in a “floating” manner permitting a certain translational movement of the shut-off element in the cavity, or in a “guided” manner by means of a pivot pin. A seal is provided between the outer surface of the shut-off element and the inner surface of the valve body or cavity and does not allow a fluid stream or fluid flow between the inlet channel and the outlet channel along the inner surface and the outer surface, that is to say through a possible gap between the inner surface and the outer surface. This seal can be effected by one or more seal elements which are arranged between the inner surface and the outer surface, and/or by a sealing abutment of the outer surface against the inner surface.

The rotatable support of the shut-off element is configured in this embodiment in such a way that it can be rotated between a flow position or open position and a shut-off position or closed position, for example by manual actuation of a suitable mechanical actuation mechanism or electrically with the aid of a servomotor. In the flow position, the inlet channel is in fluid communication with one of the two first openings, and the outlet channel is in fluid communication with the other of the two first openings, such that a fluid stream or a fluid flow is possible between the inlet channel and the outlet channel through the shut-off element through-channel. Within the scope of this application, a fluid communication or connection between two elements is usually understood to mean that a fluid can flow between the two elements, for example air in particular. In the shut-off position, the mouth openings of the inlet channel and of the outlet channel are spaced from the two first openings in the circumferential direction of the shut-off element or in the rotational direction or at an angle, and the shut-off element and the seal block any fluid stream or any fluid flow between the inlet channel and the outlet channel. The fact that an opening in the valve body and an opening in the shut-off element are spaced from one another, such as each of the mouth openings and each of the first openings in the shut-off position of the shut-off element, means in the scope of this application in the usual manner that the corresponding openings are not aligned with one another or do not overlap, or, in other words, that there is an angular distance provided therebetween or the opening in the shut-off element is spaced from the projection of the opening in the valve body on the surface of the shut-off element.

Further, in this embodiment the first pressure-compensation channel, which is formed in the shut-off element and which opens into the shut-off element through-channel at one of its two ends that are opposite along the direction of extension through the shut-off element, namely the inner end, ends at its other, outer end in a second opening in the outer surface of the shut-off element, said second opening being spaced from the two first openings, in one example in a spherically curved portion of the outer surface. The second pressure-compensation channel is formed in the valve body in such a way that at its two ends, arranged opposite along the direction of extension through the valve body, on the one hand it opens to the outside of the valve body and on the other hand ends in a third opening in the inner surface of the valve body or the wall delimiting the cavity, said third opening being spaced from the inlet channel and the outlet channel and the mouth openings thereof into the cavity.

The shut-off valve is formed in this embodiment such that, in the shut-off position of the shut-off element, the second opening is in fluid communication with the outlet channel and the third opening is in fluid communication with one of the first openings, such that a fluid, in particular compressed air for example, can flow off through the outlet channel, from there through the second opening, from there through the first pressure-compensation channel, from there through the shut-off element through-channel, from there through the first opening in fluid communication with the third opening and into the third opening, and from there through the second pressure-compensation channel to the outside of the valve body. In other words, the outlet channel is open to the atmosphere in the shut-off position.

Further, in this embodiment, in the flow position of the shut-off element the second opening and the third opening are also spaced in the circumferential direction of the shut-off element or angularly from one another and from the inlet channel and the outlet channel or the mouth openings thereof. This means that the second opening is arranged opposite the inner surface of the valve body and the third opening is arranged opposite the outer surface of the shut-off element. The seal is formed such that a fluid stream or a fluid flow between the inlet channel and the second and third opening and a fluid stream or a fluid flow between the outlet channel and the second and third opening is impossible. In other words, the opening of the outlet channel to the atmosphere is blocked or prevented in the flow position.

This embodiment has the advantage of a particularly simple construction and particularly low complexity.

In this embodiment the inlet channel, the outlet channel, the first openings, the second opening and the third opening are arranged such that, in the flow position of the shut-off element, the first openings are aligned with the mouths or mouth openings of the inlet channel and of the outlet channel into the cavity and the second and third opening are spaced from the mouths or mouth openings of the inlet channel and of the outlet channel into the cavity and are spaced from one another, and such that, in the shut-off position of the shut-off element, the second opening is aligned with one of the two first openings and the other of the two first openings is aligned with the third opening. The fact that an opening in the inner surface of the valve body and an opening in the outer surface of the shut-off element are aligned with one another means within the scope of this application in the usual manner that the corresponding openings are arranged directly opposite, over a gap potentially present between the inner surface and the outer surface, and that they are centered relative to one another, that is to say their central axes lie on a common straight line.

In one example, the inlet channel and the mouth opening thereof into the cavity, the outlet channel and the mouth opening thereof into the cavity, the first openings, the second opening, the third opening and the seal are arranged such that, as the shut-off element is rotated from the flow position into the shut-off position, a fluid stream or a fluid flow between the inlet channel and the outlet channel is at first blocked before the second opening is gets into fluid communication with the outlet channel and/or the third opening gets into fluid communication with one of the first openings. Due to this construction, by means of which the first pressure-compensation channel and/or the second pressure-compensation channel only then gets/get into fluid communication with the outlet channel as the shut-off element is rotated from the flow position into the shut-off position if the inlet channel is blocked with respect to the outlet channel by the shut-off element and a fluid communication from the inlet channel via the third opening to the atmosphere is prevented, the opening of the outlet channel to the atmosphere is effected in an advantageous manner simply by closing the shut-off valve with no further process or operating steps. Otherwise, it would potentially be necessary to provide an additional vent valve, for example in the second pressure-compensation channel.

If the two preceding examples are combined, in the flow position of the shut-off element, the maximum angular distance between the edge of the first opening aligned with the inlet channel and the edge of the mouth opening of the inlet channel is smaller than the minimum angular distance between the edge of the first opening aligned with the outlet channel and the edge of the second opening. In other words, upon rotation of the shut-off element from the flow position into the shut-off position the second opening is spaced from the mouth opening of the outlet channel in the circumferential direction of the shut-off element until the first opening aligned with the inlet channel in the flow position of the shut-off element is spaced from the inlet channel in the circumferential direction of the shut-off element. If the seal, for example due to seal elements arranged in the immediate vicinity of the mouth openings of the inlet channel and of the outlet channel or in the immediate vicinity of the first openings, is designed such that any entry of fluid from the inlet channel and the outlet channel between the shut-off element and the wall of the cavity is prevented or the extent of such an entry is limited, the result is obtained in a simple manner by the above configuration that the outlet channel is opened to the atmosphere only then when the shut-off element and the seal block a fluid stream or a fluid flow between the inlet channel and outlet channel. Alternatively or additionally, it may be preferred if, in the flow position of the shut-off element, the maximum angular distance between the edge of the first opening aligned with the inlet channel and the edge of the mouth opening of the inlet channel is smaller than the minimum angular distance between the edge of the first opening aligned with the outlet channel and the edge of the third opening. In other words, then the third opening, as the shut-off element is rotated from the flow position into the shut-off position, is spaced from the first opening aligned with the outlet channel in the flow position of the shut-off element until the first opening aligned with the inlet channel in the flow position of the shut-off element is spaced from the inlet channel in the circumferential direction of the shut-off element.

In one example, the seal comprises one or more seal elements, which are arranged between the inner surface and the outer surface, wherein generally in each case one resealing element is respectively arranged immediately adjacent to the mouth openings of the inlet channel and the outlet channel into the cavity and these two seal elements prevent the entry of fluid from the inlet channel and the outlet channel between the inner surface and the outer surface.

A shut-off valve of the above construction, generally a ball-type shut-off valve, may advantageously be used in a compressed gas system, in particular a compressed air system, for conditioning a compressed gas delivered by a compressed gas source, in one example, to cool, dewater and/or to reduce the pressure of the compressed gas delivered by the compressed gas source. The compressed gas system has an input connection for connection of a compressed gas source, an output connection or a plurality of output connections for the connection of devices to be supplied with compressed gas, and an arrangement arranged between the input connection and the one output connection or the plurality of output connections for conditioning (in particular for cooling, dewatering and/or for reducing the pressure of the compressed gas delivered by the compressed gas source) compressed gas introduced into the compressed gas system via the input connection. Said compressed gas system further comprises a shut-off valve according to one of the above-explained embodiments, wherein either the inlet or inlet channel thereof is connected to the input connection and the outlet or outlet channel thereof is connected to the arrangement for conditioning compressed gas or the outlet or outlet channel thereof is connected to the input connection. In the latter case, the inlet or inlet channel of the shut-off valve in practice constitutes the input connection of the compressed gas system.

Such a compressed gas system or even independently thereof a shut-off valve (generally a ball-type shut-off valve) of the above construction can be used advantageously in a hydraulic system. The hydraulic system comprises a hydraulic fluid reservoir, a compressed gas source, in one example, a compressed air source, and a compressed gas system of the above construction, of which the input connection is connected to the compressed gas source, wherein at least one of the output connections of the compressed gas system is connected to the hydraulic fluid reservoir, and/or a shut-off valve (generally a ball-type shut-off valve) of the above construction, which is arranged in a fluid line of the hydraulic system. The shut-off valve in a simple manner then enables the compressed gas feed or a fluid feed to be shut off and allows the pressure compensation or equalization of the shut-off region, such as, in particular, of the compressed gas system.

A shut-off valve, generally in the form of a ball-type shut-off valve, a compressed gas system and/or a hydraulic system of the above construction can be used advantageously in a vehicle and for example, in an aircraft.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a cross-sectional view of a ball-type shut-off valve according to the present disclosure in the flow position or open position thereof, and

FIG. 2 shows a cross-sectional view of the ball-type shut-off valve of FIG. 1 in the shut-off position or closed position thereof

FIG. 3 schematically shows a hydraulic system of an aircraft comprising the ball-type shut-off valve of FIGS. 1 and 2.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

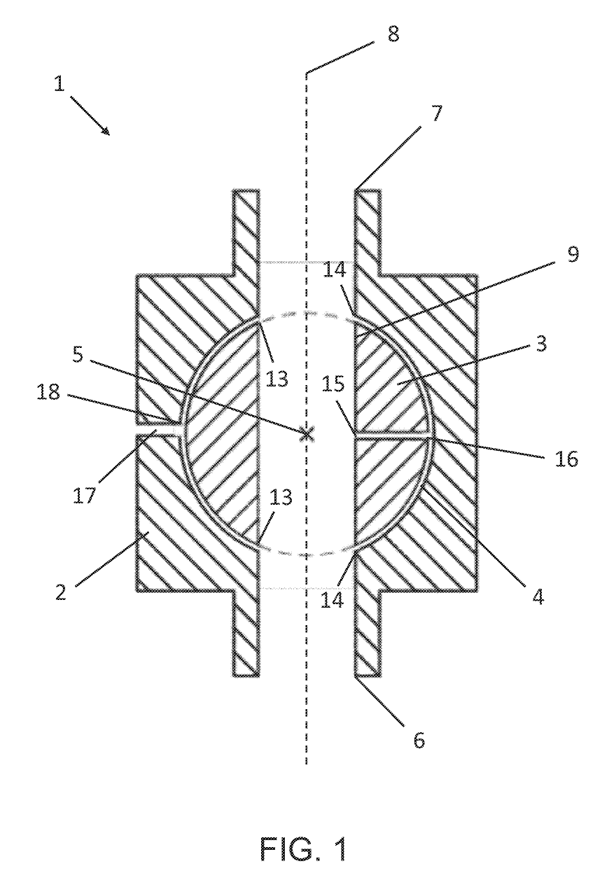

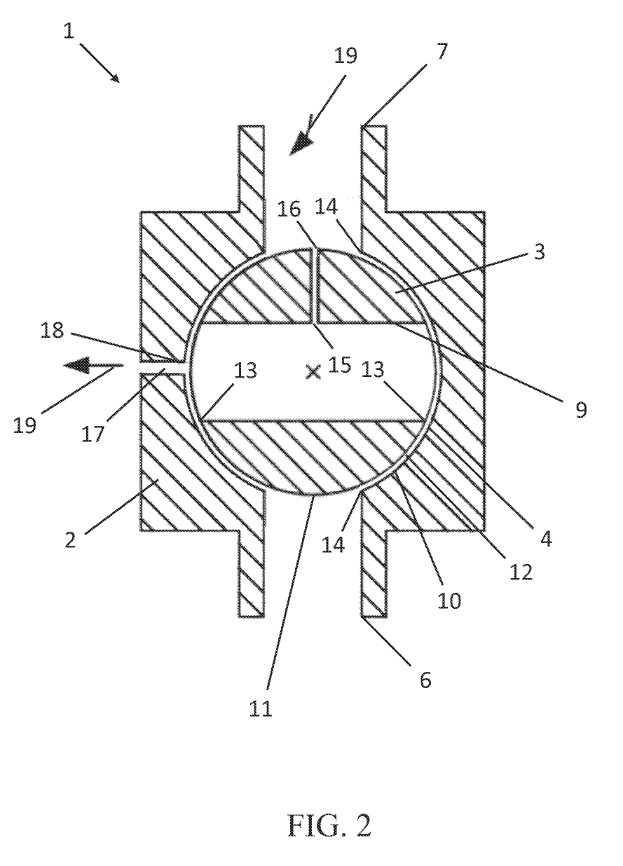

The ball-type shut-off valve 1 shown in FIGS. 1 and 2 has a valve body in the form of a casing 2 and a spherical shut-off element or body 3. The shut-off element 3 is arranged in a cavity or hollow space 4, which is likewise spherical, is formed in the casing 2 and has substantially the same size and shape as the shut-off element 3. The shut-off element 3 is supported in the cavity 4 rotatably about an axis of rotation 5, which extends substantially perpendicularly to the drawing plane through the center of the cavity 4, and can therefore be rotated through about 90° between the open position illustrated in FIG. 1 and the closed position shown in FIG. 2.

A straight inlet channel 6 and a straight outlet channel 7, which have the same diameter and are circular in cross section for example, are also provided in the casing 2. They are arranged on opposite sides of the cavity 4 offset from one another by about 180°, and their central axes lie on a common straight line 8. A corresponding straight through-channel or through-bore 9 is formed in the shut-off element 3 and for example has the same diameter and the same cross-sectional shape as the inlet channel 6 and the outlet channel 7 and extends centrally through the shut-off element 3.

In the position of the shut-off element 3 illustrated in FIG. 1, the through-channel 9 is aligned with the inlet channel 6 and the outlet channel 7, such that it forms, jointly therewith, a through-channel through the valve 1, through which compressed air can flow. Seal elements (not shown) are arranged between the spherical inner surface 10 of the casing 2 delimiting the cavity 4 and the spherical outer surface 11 of the shut-off element 3 and prevent an entry of compressed air from the inlet channel 6 and the outlet channel 7 into the gap 12 between the inner surface 10 and the outer surface 11 and therefore prevent a flow of compressed air between the inlet channel 6 and the outlet channel 7 through the gap 12. Alternatively, this may also be effected by a sealing abutment between the inner surface 10 and outer surface 11. In this open position of the valve 1, in which a flow of compressed air is possible between the inlet channel 6 and outlet channel 7, the two openings 13 at the ends of the through-channel 9 of the shut-off element 3 are aligned with the mouth openings 14 of the inlet channel 6 and of the outlet channel 7 into the cavity 4.

In the position of the shut-off element 3 illustrated in FIG. 2, the through-channel 9 is by contrast rotated by about 90° with respect to the inlet channel 6 and the outlet channel 7, and the two openings 13 at the ends of the through-channel 9 are spaced in the circumferential direction of the shut-off element 3 from the mouth openings 14 of the inlet channel 6 and of the outlet channel 7, such that the shut-off element 3, together with the seal elements, prevents compressed air from passing from the inlet channel 6 to the outlet channel 7.

Further, a straight pressure-compensation channel 15 is formed in the shut-off element 3 and extends substantially perpendicularly to the through-channel 9 and at one end opens into said through-channel in the middle between the two openings 13 at the ends of the through-channel 9 and, at its opposite end, ends in an opening 16 in the outer surface 11 of the shut-off element 3. A further straight pressure-compensation channel 17 is formed in the casing 2 and extends substantially perpendicularly to the inlet channel 6 and the outlet channel 7 or the line 8 and, at one end, ends in an opening 18 in the inner surface 10, and, at the opposite end, is open to the atmosphere. The opening 16 is arranged in the middle between the two openings 13 at the ends of the through-channel 9, and the opening 18 is arranged in the middle between the two mouth openings 14 of the inlet channel 6 and of the outlet channel 7. The pressure-compensation channels 15 and 17 have a smaller diameter than the inlet channel 6, the outlet channel 7 and the through-channel 9 and may have a circular cross section for example.

In the open position shown in FIG. 1, the pressure-compensation channel 15 is arranged spaced from the pressure-compensation channel 17 on the opposite side of the shut-off element 3 in such a manner that the openings 16 and 18 are spaced from one another by about 180° along the periphery or circumference of the shut-off element 3. The openings 16 and 18 are arranged opposite a closed portion of the inner surface 10 and the outer surface 11, respectively, and it is not possible for compressed air to flow therebetween. The inlet channel 6 and the outlet channel 7 are therefore closed to the atmosphere.

If the shut-off element 3 is now rotated anticlockwise from the position in FIG. 1 in the direction of the position in FIG. 2, the shut-off element 3 increasingly closes the inlet channel 6 and the outlet channel 7 since the mouth openings 14 of the inlet channel 6 and of the outlet channel 7 are covered increasingly by the outer surface 11 of the shut-off element 3. In addition, the opening 16 of the pressure-compensation channel 15 of the shut-off element 3 eventually reaches the mouth opening 14 of the outlet channel 7, whereby a compressed air connection is established therebetween, and one of the openings 13 at the ends of the through-channel 9 reaches the opening 18, whereby a compressed air connection is established therebetween. In the position shown in FIG. 2, the opening 16 of the pressure-compensation channel 15 of the shut-off element 3 and the mouth opening 14 of the outlet channel 7 on the one hand and the corresponding opening 13 and the opening 18 on the other hand are aligned or centered with one another respectively and are arranged directly opposite one another. In this position, the compressed air flow between the inlet channel 6 and outlet channel 7 is blocked, and the outlet channel 7 is open to the atmosphere via the pressure-compensation channel 15, the opening 16, part of the through-channel 9, the opening 13, the opening 18 and the pressure-compensation channel 17, as is indicated by the arrows 19 in FIG. 2.

The angular diameter of the mouth openings 14 and of the openings 13 at the ends of the through-channel 9 is smaller than the angular distance between the edge of the opening 16 and the edge of each of the openings 13 at the ends of the through-channel 9. During the described rotational movement, the mouth openings 14 of the inlet channel 6 and of the outlet channel 7 are therefore covered and closed completely by the outer surface 11 of the shut-off element 3 before the opening 16 of the pressure-compensation channel 15 of the shut-off element 3 reaches the mouth opening 14 of the outlet channel 7 and a compressed air connection is thus established therebetween. The outlet channel 7 is therefore only opened to the atmosphere when the compressed air feed from the inlet channel 6 to the outlet channel 7 is shut off, such that there is at no point a connection from the inlet channel 6 via the pressure-compensation channel 17 to the atmosphere, whereby unnecessary discharge of compressed air fed from the pressure source is prevented along with the associated noise generation.

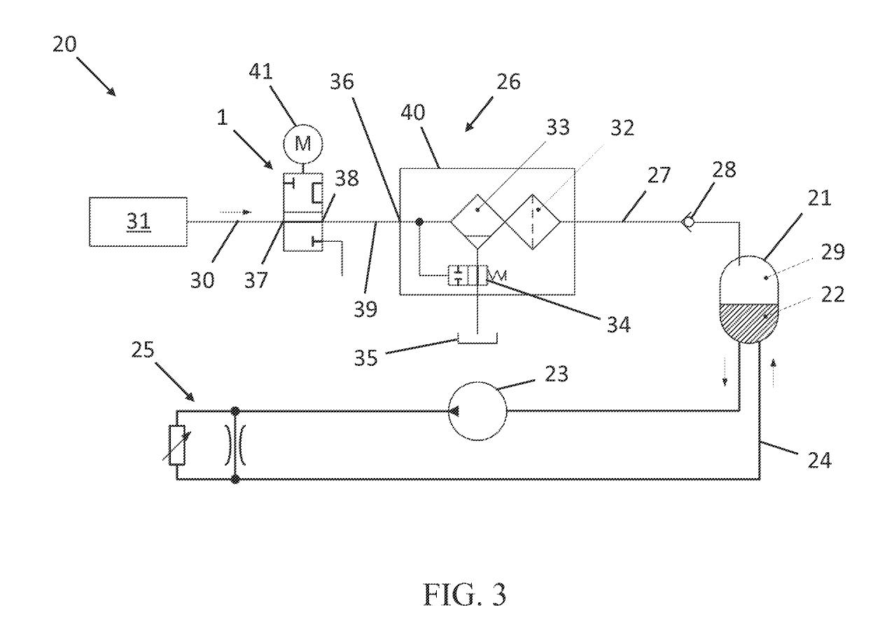

This ball-type shut-off valve 1 may advantageously form part of a hydraulic system of a vehicle. An example for such a hydraulic system 20 is illustrated schematically and in a simplified manner in FIG. 3.

The hydraulic system 20 comprises a reservoir 21, in which a hydraulic fluid 22 is located. The hydraulic fluid 22 is pumped with the aid of a hydraulic pump 23 via a line 24 in a closed circuit to hydraulic consumers 25 (only one hydraulic consumer is shown in FIG. 3 for reasons of clarity), and, once work has been performed in the hydraulic consumers 25, is pumped back again to the reservoir 21. It is noted in this regard that a hydraulic system in practice not only has a plurality of hydraulic consumers 25, but may also have a plurality of hydraulic pumps 23, hydraulic reservoirs 21 and/or circuits 24.

In accordance with the above explanations, the hydraulic system 20 further comprises a compressed air system 26, which is connected to the reservoir 21 via a compressed air line 27, in which a check valve 28 is provided. The compressed air system 26 is designed and adapted to apply compressed air 29 to the reservoir 21 or the hydraulic fluid 22 located in the reservoir 21 in order to ensure efficient drawing of the hydraulic fluid 22 from the reservoir 21 by the pump 23.

The compressed air system 26 procures the compressed air 29 for its part via a line 30 from a compressed air source 31, which is formed or constituted by the existing compressed air system of the aircraft or a bleed air source of the aircraft, and is further designed and adapted to condition the compressed air 29 for the intended application before the compressed air is fed to the reservoir 21. In the shown example, the conditioning, besides the cooling of the compressed air 29 and the pressure reduction to a suitable level, also comprises the dewatering and filtering of the compressed air 29. For this purpose, the compressed air system 26 comprises an air filter 32 and a water separator 33. The water separated by the water separator 33 and collected therein can be drained via a water drain valve 34 into a water collection device 35.

In order to maintain the function of the compressed air system 26 and of the water separator 33, the separated water must be drained regularly. In order to perform this without risk and using simple means, the compressed air system 26 comprises the ball-type shut-off valve 1 of the above-described construction, by means of which the compressed air system 26 can be switched to a pressure-free state. The inlet channel 37 of the ball-type shut-off valve 1 is connected via the line 30 to the compressed air source 31, and the outlet channel 38 of the ball-type shut-off valve 1 is connected via a line 39 to an inlet connection 36 of a working unit 40 of the compressed air system 26 containing the air filter 32 and the water separator 33. It should be noted that the working unit 40 itself could also be considered as a compressed air system, wherein the ball-type shut-off valve 1 would then have to be considered an external component connected to said compressed air system.

During normal operation, the ball-type shut-off valve 1 or the shut-off element 3 thereof is arranged in the open position shown in FIG. 1. By operating a servomotor 41, the ball-type shut-off valve 1 or the shut-off element 3 thereof can be brought into the closed position shown in FIG. 2, whereby the compressed air feed or supply to the working unit 40 is blocked and the pressure in the compressed air system 26 is brought to ambient pressure in one operating step in the described manner. The check valve 28 prevents hydraulic fluid 22 from entering the compressed air system 26.

The water drain valve 34 is spring-loaded and is configured such that it is forced against the force of a spring into the closed position by the pressure prevailing in the compressed air system 26 under normal operation. If the compressed air system 26 is switched to a pressure-free state by suitable actuation of the ball-type shut-off valve 1, the water drain valve 34 opens automatically due to the force of the spring.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A shut-off valve comprising:
a valve body including an inlet and an outlet, and
a shut-off element, which is arranged in the valve body and through which a shut-off element through-channel is defined, the shut-off element through-channel having two ends, which terminate at two mutually spaced first openings in an outer surface of the shut-off element,
wherein the shut-off element is supported in the valve body in such a way that the shut-off element is movable between a shut-off position of the shut-off element, in which the shut-off element blocks a fluid flow between the inlet and the outlet of the valve body, and a flow position of the shut-off element, in which the shut-off element allows a fluid flow between the inlet and the outlet of the valve body through the shut-off element through-channel,
wherein the shut-off element comprises a first pressure-compensation channel opening with an inner end into the shut-off element through-channel, and the valve body comprises a second pressure-compensation channel,
wherein, in the shut-off position of the shut-off element, the shut-off element allows a pressure compensation from the outlet into an outer end of the first pressure-compensation channel, from the first pressure-compensation channel into the shut-off element through-channel, and from the shut-off element through-channel through one of the first openings thereof into the second pressure-compensation channel, and, in the flow position of the shut-off element, the shut-off element blocks a pressure compensation between the outlet and the second pressure-compensation channel.

2. The shut-off valve according to claim 1, wherein, in the shut-off position of the shut-off element, one end of the second pressure-compensation channel is located directly at one of the first openings of the shut-off element through-channel, and, in the flow position of the shut-off element, said one end of the second pressure-compensation channel is closed directly by the valve body.

3. The shut-off valve according to claim 1, wherein:
the valve body comprises a cavity, which is delimited by an inner surface of the valve body, and the inlet and the outlet are formed by an inlet channel and an outlet channel, respectively, of the valve body, which open at mutually spaced mouths into the cavity and, together with the cavity, form a part of a passage through the valve body, along which the cavity is arranged between the inlet channel and the outlet channel, and
the shut-off element is arranged in the cavity and is supported rotatably about at least one axis, and a seal is provided between the outer surface of the shut-off element and an inner surface of the valve element and prevents a fluid flow between the inlet channel and the outlet channel along the inner surface and the outer surface,
wherein the shut-off element is rotatable between the flow position, in which the inlet channel is in fluid communication with one of the two first openings and the outlet channel is in fluid communication with the other of the two first openings such that fluid flows between the inlet channel and the outlet channel through the shut-off element through-channel, and the shut-off position, in which the inlet channel and the outlet channel are spaced from the two first openings in the circumferential direction of the shut-off element and the shut-off element and the seal prevent a fluid flow between the inlet channel and the outlet channel.

4. The shut-off valve according to claim 1, wherein the shut-off element through-channel and the first pressure-compensation channel are straight, and the first pressure-compensation channel extends perpendicularly to the shut-off element through-channel.

5. The shut-off valve according to claim 4, wherein the first pressure-compensation channel opens into the shut-off element through-channel in the middle between the two first openings.

6. The shut-off valve according to claim 1, wherein the shut-off element is rotated through 90° when moved between the flow position and the shut-off position.

7. The shut-off valve according to claim 17, wherein the inlet channel, the outlet channel, the first openings, the second opening and the third opening are arranged such that,
in the flow position of the shut-off element, the first openings are respectively aligned with the mouths of the inlet channel and of the outlet channel into the cavity and the second and third opening are spaced from the mouths of the inlet channel and of the outlet channel into the cavity and from one another in the circumferential direction of the shut-off element, and,
in the shut-off position of the shut-off element, the second opening is aligned with one of the two first openings and the other of the two first openings is aligned with the third opening.

8. The shut-off valve according to claim 7, wherein the inlet channel, the outlet channel, the first openings, the second opening, the third opening and the seal are arranged such that, as the shut-off element is rotated from the flow position into the shut-off position, a fluid flow is at first blocked between the inlet channel and the outlet channel before at least one of the second opening becomes in fluid communication with the outlet channel and the third opening becomes in fluid communication with one of the first openings.

9. The shut-off valve according to claim 8, wherein, in the flow position of the shut-off element, the maximum angular distance between the edge of the first opening aligned with the inlet channel and the edge of the mouth of the inlet channel into the cavity is smaller than the minimum angular distance between the edge of the first opening aligned with the outlet channel and the edge of the second opening.

10. The shut-off valve according to claim 1, wherein
the diameter of at least one of the first pressure-compensation channel and of the second pressure-compensation channel is smaller than the diameter of at least one of the shut-off element through-channel, of the inlet and of the outlet, and the diameter of the first pressure-compensation channel is smaller than the diameter of the second pressure-compensation channel.

11. The shut-off valve according to claim 3, wherein the seal comprises one or more seal elements, which are arranged between the inner surface and the outer surface.

12. The shut-off valve according to claim 11, wherein one seal element is arranged directly adjacent to the mouth of the inlet channel into the cavity and one seal element is arranged directly adjacent to the mouth of the outlet channel into the cavity, wherein the two seal elements prevent the entry of fluid from the inlet channel and the outlet channel between the inner surface and the outer surface.

13. A compressed gas system for conditioning a compressed gas delivered by a compressed gas source, comprising:
an input connection for connection of the compressed gas source,
at least one output connection,
an arrangement for conditioning compressed gas introduced into the compressed gas system via the input connection, said arrangement being arranged between the input connection and the at least one output connection, and
a shut-off valve including a valve body having an inlet and an outlet, and a shut-off element, which is arranged in the valve body and through which a shut-off element through-channel is defined, the shut-off element through-channel having two ends, which terminate at two mutually spaced first openings in an outer surface of the shut-off element and the shut-off element is supported in the valve body in such a way that the shut-off element is movable between a shut-off position of the shut-off element, in which the shut-off element blocks a fluid flow between the inlet and the outlet of the valve body, and a flow position of the shut-off element, in which the shut-off element allows a fluid flow between the inlet and the outlet of the valve body through the shut-off element through-channel, and the shut-off element comprises a first pressure-compensation channel opening with an inner end into the shut-off element through-channel, and the valve body comprises a second pressure-compensation channel, and in the shut-off position of the shut-off element, the shut-off element allows a pressure compensation from the outlet into an outer end of the first pressure-compensation channel, from the first pressure-compensation channel into the shut-off element through-channel, and from the shut-off element through-channel through one of the first openings thereof into the second pressure-compensation channel, and, in the flow position of the shut-off element, the shut-off element blocks a pressure compensation between the outlet and the second pressure-compensation channel,
wherein the inlet is connected to the input connection and of which the outlet is connected to the arrangement for conditioning compressed gas.

14. A hydraulic system comprising:
a hydraulic fluid reservoir,
a compressed gas source,
a compressed gas system, of which an input connection is connected to the compressed gas source, wherein at least one of the output connections of the compressed gas system is connected to the hydraulic fluid reservoir, and
a shut-off valve, which is arranged in a fluid line of the hydraulic system, the shut-off valve including a valve body having an inlet and an outlet, and a shut-off element, which is arranged in the valve body and through which a shut-off element through-channel is defined, and the shut-off element is supported in the valve body in such a way that the shut-off element is movable between a shut-off position of the shut-off element, in which the shut-off element blocks a fluid flow between the inlet and the outlet of the valve body, and a flow position of the shut-off element, in which the shut-off element allows a fluid flow between the inlet and the outlet of the valve body through the shut-off element through-channel, and the shut-off element comprises a first pressure-compensation channel opening with an inner end into the shut-off element through-channel, and the valve body comprises a second pressure-compensation channel, and in the shut-off position of the shut-off element, the shut-off element allows a pressure compensation, and in the flow position of the shut-off element, the shut-off element blocks a pressure compensation between the outlet and the second pressure-compensation channel.

15. An aircraft, comprising:
a hydraulic system having a fluid line,
a shut-off valve which is arranged in the fluid line, the shut-off valve including a valve body having an inlet and an outlet, and a shut-off element, which is arranged in the valve body and through which a shut-off element through-channel is defined, the shut-off element through-channel having two ends, which terminate at two mutually spaced first openings in an outer surface of the shut-off element and the shut-off element is supported in the valve body in such a way that the shut-off element is movable between a shut-off position of the shut-off element, in which the shut-off element blocks a fluid flow between the inlet and the outlet of the valve body, and a flow position of the shut-off element, in which the shut-off element allows a fluid flow between the inlet and the outlet of the valve body through the shut-off element through-channel, and the shut-off element comprises a first pressure-compensation channel opening with an inner end into the shut-off element through-channel, and the valve body comprises a second pressure-compensation channel, and in the shut-off position of the shut-off element, the shut-off element allows a pressure compensation from the outlet into an outer end of the first pressure-compensation channel, from the first pressure-compensation channel into the shut-off element through-channel, and from the shut-off element through-channel through one of the first openings thereof into the second pressure-compensation channel, and, in the flow position of the shut-off element, the shut-off element blocks a pressure compensation between the outlet and the second pressure-compensation channel.

16. The shut-off valve according to claim 3, wherein the first pressure-compensation channel formed in the shut-off element ends at its outer end in a second opening in the outer surface of the shut-off element, said second opening being spaced from the first two openings, and the second pressure-compensation channel formed in the valve body opens at one end to the outside of the valve body and ends at the other end in a third opening in the inner surface of the valve body, said third opening being spaced from the inlet channel and the outlet channel.

17. The shut-off valve according to claim 16, wherein in the shut-off position of the shut-off element, the second opening is in fluid communication with the outlet channel and the third opening is in fluid communication with one of the first openings, such that fluid flows from the outlet channel through the second opening, through the first pressure-compensation channel, through the shut-off element through-channel, through the first opening in fluid communication with the third opening into the third opening and through the second pressure-compensation channel to the outside of the valve body, and in the flow position of the shut-off element, the second opening and the third opening are spaced from one another and from the inlet channel and the outlet channel in the circumferential direction of the shut-off element, and the seal is configured such that it prevents a fluid flow between the inlet channel and the second and third opening and prevents a fluid flow between the outlet channel and the second and third opening.

18. The aircraft according to claim 15, wherein the shut-off element is rotated through 90° when moved between the flow position and the shut-off position.

19. The aircraft according to claim 15, wherein the shut-off element through-channel and the first pressure-compensation channel are straight, and wherein the first pressure-compensation channel extends perpendicularly to the shut-off element through-channel.

20. The aircraft according to claim 19, wherein the first pressure-compensation channel opens into the shut-off element through-channel in the middle between the two first openings.
